(19) United States
(12) Patent Application Publication
(10) Pub. No.: US 2009/0167060 A1
(43) Pub. Date: Jul. 2, 2009

(54) Vehicle Hood and a Method of Fabricating Such a Hood

(75) Inventors: Dominique Zanolin, Le Chesnay (FR); Laurent Martin, Peaugres (FR); Yvon Tetu, La Garenne Colombes (FR)

Correspondence Address: OLIFF & BERRIDGE, PLC, P.O. BOX 320850, ALEXANDRIA, VA, 22320-4850, US

(73) Assignees: INOPLAST, ANNONAY (FR); RENAULT SAS, BOULOGNE BILLANCOURT (FR)

(21) Appl. No.: 12/085,911

(22) PCT Filed: Nov. 30, 2006
(86) PCT No.: PCT/FR2006/051262

§ 371 Date: Oct. 8, 2008

(30) Foreign Application Priority Data
Dec. 1, 2005 (FR) 0512202

(51) Int. Cl. B62D 25/10

(52) U.S. Cl. 296/193.11

(57) ABSTRACT

The hood comprises an outer skin and an inner lining made of SMC, the lining extending essentially at a distance from the skin. This structure enables the hood to present satisfactory mechanical behavior in terms of protecting the head of a pedestrian striking the hood: because of the SMC, the hood then deforms essentially elastically without breakage, with predetermined uniform behavior.

The present invention relates to a vehicle hood, in particular for a motor vehicle, and also to a method of fabricating such a hood.

### BACKGROUND OF THE INVENTION

The invention addresses the general problem of protecting pedestrians in the event of a front impact against a vehicle, in particular a motor vehicle. To quantify the severity of an impact caused to the head of a pedestrian striking the hood of a vehicle when the pedestrian is knocked over by the vehicle, car manufacturers and component suppliers generally make use of a head injury criterion (HIC). The HIC criterion is specific to each type of hood and gives an indication of the intensity of the impact between the head and the hood, essentially by taking account of the maximum deceleration to which the pedestrian's head is subjected during an impact.

In order to satisfy the HIC level, document WO-A-03/04263 proposes a hybrid hood structure comprising a metal outer skin and an inner lining of bulk molding compound (BMC), sometimes also referred to as “premix”. BMC is a brittle composite material constituted by a mixture of resin, reinforcement, fillers, etc., not in the form of fabric, and generally prepared by injection-molding prior to use. The use of BMC seeks to make it possible during the initial stage of an impact between the hood and the head of a pedestrian to decelerate the pedestrian's head quite quickly and then, during a subsequent stage of the impact, to prevent the head coming completely to rest too suddenly, by making provision for the inner layer of BMC to break in brittle manner. Nevertheless, tests for assessing the brittle nature of BMC present a major drawback: since breakage of the BMC is random, or at least difficult to predetermine in accurate manner, HIC measurements present a very large dispersion, whether for a plurality of structurally identical hoods, or for a single hood when tested at different points.

### OBJECTS AND SUMMARY OF THE INVENTION

The object of the present invention is to propose a hybrid structure hood that, in the event of an impact with the head of a pedestrian, presents mechanical behavior that is satisfactory for the HIC, in a manner that is both predetermined and uniform.

To this end, the invention provides a vehicle hood in particular for a motor vehicle, the hood comprising an outer skin and an inner layer of composite material, wherein the layer forms a lining made of SMC and extending essentially at a distance from the skin.

The abbreviation SMC stands for sheet molding compound that is sometimes also known as pre-impregnated. SMC is a preform in the form of one or more sheets made of yarns, mats, or fabric of organic or mineral fibers, impregnated with resin. SMC is thus an integrated composition ready for molding, being transformed by compression, thereby limiting creep of the synthetic material during molding and thus reducing damage and orientation of the fibers in the final product.

The SMC lining of the hood of the invention possesses characteristics of flexibility, thereby imparting uniform mechanical behavior to the hood: during deceleration of a pedestrian's head striking the hood, the hood deflects elastically and without breaking, at least during the initial stage of the impact. In the event of the hood being free to move back without encountering a hard point in the engine zone of the vehicle, the hood deflects essentially, or even exclusively, elastically and without breaking, with behavior that is predetermined and precise: the hood presents overall rigidity that is uniform, associated with the rigidities of the skin and of the SMC lining. If the indentation of the hood leads to the SMC lining coming to bear against a hard point in the engine zone, the flexibility of the SMC enables the lining to deform locally, at the periphery of the hard point, so as to prevent the pedestrian's head being stopped suddenly. The SMC lining is thus suitable for deflecting while buckling overall, when it deforms over its entire extent, and/or by flattening locally, with the lining then advantageously forming portions of extra thickness that are designed to fail by being flattened without buckling.

In practice, the SMC lining is assembled to the metal skin in such a manner as to maintain a spacing between the major fractions of the skin and of the lining, i.e. outside small zones where the skin and the lining touch each other, and in particular outside peripheral zones of the skin and the lining. This spacing between the skin and the lining enables the overall structure of the hood to generate an inertia that is compatible with the various requirements for the product, in particular in terms of static stiffness, i.e. static resistance to bending and twisting. In addition, the SMC lining as spaced apart in this way enables the hood of the invention to be better adapted to the under-hood configuration of the engine zone, without changing the overall outside shape as defined by the skin: additional functions can then be integrated in the lining, for example an air duct type function opening out in the vicinity of an engine battery in order to cool it.

The use of SMC also presents other advantages. The resin of the SMC may conduct electricity, thus enabling paint or an electrostatic coating to be applied, in particular along an assembly line. In addition, SMCs have elasticity modulus lying in the range 5000 megapascals (MPa) to 40,000 MPa, approximately, thus making it possible in a particular application to select an SMC having a modulus that is better suited to optimizing the HIC value of the hood and/or the maximum depth to which the hood is indented. Furthermore, a single skin can be used equally well with two different linings made of SMCs having different moduluses in order to obtain two hoods satisfying regulations or recommendations that differ in terms of pedestrian protection level.

In a first general embodiment, the outer skin of the hood is made of metal, being made of steel, aluminum, or any other metal alloy in use in the car bodywork field.

In a second general embodiment, the outer skin of the hood is made of a thermoplastic or composite material, e.g. of SMC. The resulting hood presents smaller stiffness than does a hood having a metal skin, and it can be used for example to cover a front trunk for a vehicle having its engine provided at the rear.

According to other characteristics of the hood, taken individually or in any other technically feasible combination:
the volume defined between the skin and the lining is left empty;
on its face facing away from the skin, the lining presents at least one surface for bearing against a rigid element of the body of the vehicle;
the lining includes at least one deformed zone projecting from the remainder of the lining away from the skin, the bearing surface being provided by said deformed zone;
the skin and the lining are permanently secured to each other via spots and/or lines of adhesive interposed between the face of the skin facing towards the lining and the face of the lining facing towards the skin; and
the hood further includes at least one rigid baseplate adapted to set the relative position of the skin and the lining, at least temporarily, in particular before said skin and said lining are permanently secured to each other.

The invention also provides a method of fabricating a vehicle hood, in particular for a motor vehicle, in which an outer skin is provided for the hood, wherein during a step that is independent of obtaining the skin, an SMC layer is molded in order to provide an inner lining for the hood, and wherein, after the steps of obtaining the skin and molding the SMC layer, the skin and the lining are permanently connected together so that the skin covers the lining, with the lining extending essentially at a distance from the skin.

The method of the invention makes it possible to obtain a hood as defined above. The method thus makes it possible to obtain a hood of hybrid structure, presenting a satisfactory HIC, by using essentially the flexible mechanical characteristics of the SMC lining that is molded independently of obtaining the outer skin of the hood.

If the outer skin of the hood to be fabricated is made of metal, then the step of obtaining said skin consists in particular in a step of shaping a metal sheet. If the outer skin is constituted by a thermoplastic or a composite material, the step of obtaining it may constitute, for example, a step of molding or the like.

According to other characteristics of the method that are advantageous:
prior to permanently securing the skin and the lining together, the skin is assembled in set position relative to the lining by using at least one rigid baseplate that is secured both to the skin and to the lining and that is disposed between the skin and the lining;
when the skin and the baseplate(s) are of a metallic nature, the or each baseplate is secured to the skin by welding or the like, so as to enable electricity to be conducted between them;
in order to secure the skin permanently to the lining when they are assembled in set position relative to each other by the baseplate(s), spots or lines of adhesive suitable for being cross-linked are interposed between the skin and the lining, and then the adhesive is caused to cross-link, preferably while the hood assembled to the remainder of the vehicle is passing through a cataphoresis bath; and
the or each baseplate is used for carrying mechanical elements associated with the hood, such as a hinge enabling the hood to be opened.

### BRIEF DESCRIPTION OF THE DRAWINGS

The invention can be understood on reading the following description given purely by way of example and made with reference to the drawings, in which:

FIG. 1 is a diagrammatic perspective view of a motor vehicle seen from in front and including a hood in accordance with the invention;

FIG. 2 is a diagrammatic section on plane II of FIG. 1;

FIG. 3 is a diagram representing the HIC of the hood in FIGS. 1 and 2;

FIG. 4 is a partially cutaway perspective view showing a detail in circle IV of FIG. 1, on a larger scale; and

FIG. 5 is a section on plane V of FIG. 4.

### MORE DETAILED DESCRIPTION

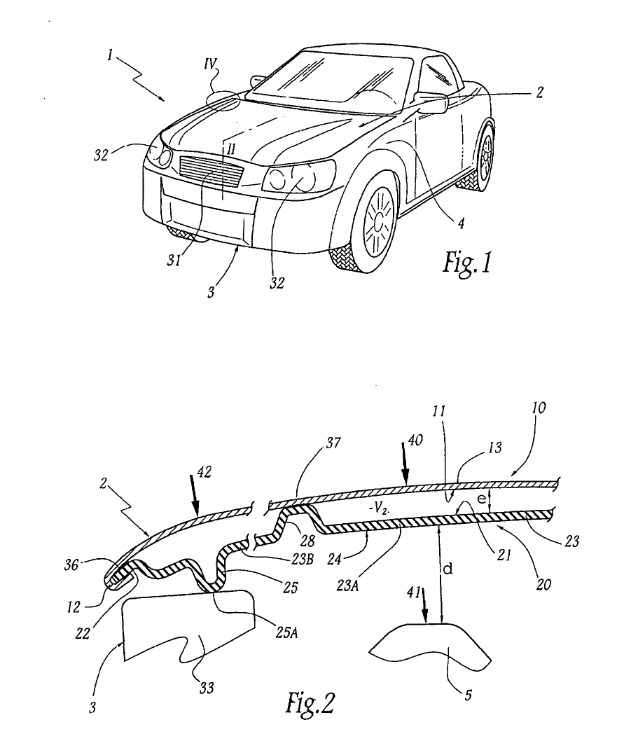

FIG. 1 shows a motor vehicle 1 having a front hood 2, a front panel 3 forming part of the body of the vehicle, and a left front fender 4. The hood 2 constitutes a protective covering for the engine of the vehicle 1, while the panel 3, placed vertically under the front end of the hood 2 carries members, such as a radiator grille 31, headlight units 32, etc.

As shown in greater detail in FIG. 2, the hood 2 comprises an outer skin 10 and an inner lining 20. The lining 20 is made of a layer of SMC composite material. The initials SMC stand for sheet molding compound, and this material is sometimes also referred to as pre-impregnated, and corresponds to a preform made of yarns, mats, or fabric of organic or mineral fibers impregnated with a resin. By way of example, the resin is constituted by an unsaturated polyester.

In the hood shown in the figures, the skin 10 is made of metal, e.g. of steel or of aluminum. In a variant that is not shown, the skin may be made of a thermoplastic material or of a composite material.

The hood 2 shown in the figures thus presents a generally hybrid structure, associating an outer metal layer with an inner composite layer.

The skin 10 forms a generally plane plate of small thickness that presents a geometrical shape that is essentially rectangular when seen from above. This basic shape may present small ridges or indentations, depending on the appearance of the front portion of the vehicle 1.

Overall, the SMC lining 20 presents a configuration analogous to that of the skin 10. In practice, the lining is thicker than the skin and presents an outline that is slightly smaller than that of the skin so that the skin covers the lining completely in order to mask it in full when seen from the outside, i.e. when the hood 2 is observed as shown in FIG. 1.

When the hood 2 is in its final assembled configuration, as shown in FIGS. 1 and 2, the SMC lining 20 is for the most part held at a distance from the metal skin 10 so as to define an empty volume V₂ between the top face 21 of the lining and the bottom face 11 of the skin, with the spacing between these faces being marked e in FIG. 2. The skin 10 and the lining 20 are permanently secured to each other via their peripheral edges, and also locally in predetermined zones of the main portions of the skin and of the lining.

More precisely, if the front peripheries of the skin and of the lining as can be seen in the left-hand portion of FIG. 2 are described in detail, the skin comprises a front peripheral edge 12 that is folded over so as to receive the front peripheral edge 22 of the lining. The edge 12 thus forms a hook that holds the lining mechanically, with this retention being advantageously reinforced by interposing a structural adhesive or analogous means, such as a peripheral line of adhesive 36.

In the main portions 13 and 23 of the skin 10 and of the lining 20, that are separated by the empty volume V₂, the faces 11 and 21 are permanently connected together by adhesive presenting little shrinkage, such as a mastic, forming spots or lines, such as the spots 37 shown in the right-hand portion of FIG. 2. Each of these spots or lines of adhesive is provided specifically in a locally-deformed zone 28 of the lining, which zone projects from the remainder of the portion 23 towards the skin. These deformed zones 28 present a height that is substantially equal to the spacing e between the skin and the lining such that the top of each deformed zone juxtaposes the face 11 of the skin, with adhesive being interposed to constitute the above-mentioned spots or lines. One or both of the other two dimensions of each deformed zone 28 is/are much smaller than the dimensions corresponding to the volume V₂ so that the volume V₂ remains essentially empty, as can be seen in FIG. 2.

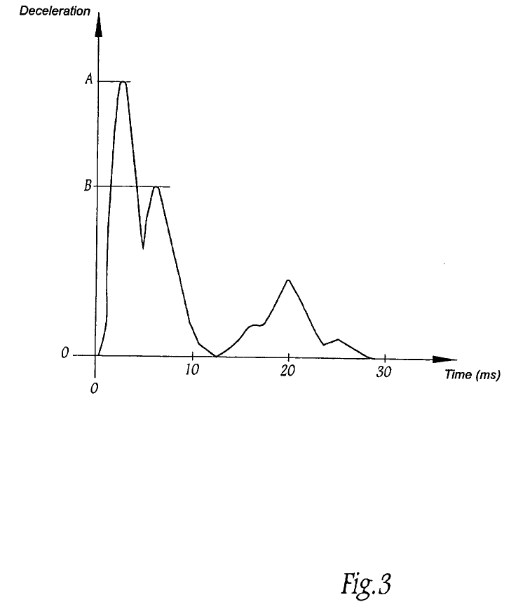

When a pedestrian is knocked over by the vehicle 1 and the pedestrian's head strikes the hood 2, the hood responds with relatively flexible mechanical behavior, suitable for limiting the HIC value. By way of example, if consideration is given to the impact presented by arrow 40, in the right-hand portion of FIG. 2, the deceleration of the pedestrian's head will vary as a function of time in a manner shown in FIG. 3, with the HIC value corresponding to a fraction of the area under the curve of FIG. 3.

Over time, this curve presents a first peak of intensity A corresponding to overall deformation of the hood 2, i.e. to the relatively rigid deformation of the skin 10 and to the flexible deformation of the SMC lining 20. It can be seen, that because of the structure of the hood, the overall rigidity of the hood remains moderate, since the lining deflects essentially elastically.

After the first intensity peak A, the curve of FIG. 3 presents a second intensity peak B associated with the presence of a hard point against which the SMC lining 20 comes to bear on deforming under the effect of the impact with the pedestrian's head. More precisely, as shown in the right-hand portion of FIG. 2, a portion 23A of the lining 20 overlies a hard point 5, e.g. constituted by a rigid member of the engine of the vehicle 1, e.g. a box or the like. Under the effect of the impact represented by arrow 40, the hood 2 deforms in the direction of arrow 41 until the bottom face 24 of the lining 20 is pressed against the hard point 5, thereby causing the deceleration of the pedestrian's head to increase up to the intensity peak B of the curve in FIG. 3. Because of the SMC, the intensity B of the deceleration associated with the presence of the hard point remains moderate, and in particular less than the intensity A of the deceleration associated with overall deformation of the hood without coming into contact with the hard point. This advantageous behavior of the hood 2 is the result of the flexible behavior of the SMC lining, and to a lesser extent of the spacing between the lining and the skin. In fact, when the SMC lining is pressed against the hard point 5, it deforms locally, at the periphery of the hard point, thereby absorbing a significant fraction of the energy released by the impact against the hard point. It will be understood that in a variant that is not shown, it is also possible to adapt the geometrical shape of the portion 23A of the lining, and in particular to adapt its thickness.

A distance d lies between the bottom face of the portion 23A of the lining and the top end of the hard point 5. The hood 2 presents advantageous behavior for a distance d that is standard, typically less than 35 millimeters (mm), as for a smaller movement.

At the front periphery of the hood 2, the distance between the SMC lining 20 and a rigid element 33 of the panel 3 is nevertheless smaller than the above-mentioned distance d. To limit the indentation stroke of the hood 2, while maintaining an acceptable HIC value, the front end portion 23B of the main portion 23 of the lining 20 includes a locally-deformed zone 25 that projects from the remainder of the portion 23 in a direction going away from the skin 10, as shown in the left-hand portion of FIG. 2. This zone 25 is dimensioned so that in the event of an impact it bears against the top end of the panel element 33 and thus provides a practically point-size corresponding bearing surface 25A. Operating clearance is provided between the zone 25 and the panel element 33, this clearance being absorbed from the beginning of the impact.

When the head of a pedestrian strikes the front end portion of the hood 2, as represented by the arrow 42 in the left-hand portion of FIG. 2, the hood 2 deforms in a manner analogous to that described above with reference to the right-hand portion of FIG. 2. Nevertheless, since the portion 23B of the lining that is under stress bears during the impact locally against the panel element 33, via the surface 25A, the indentation stroke of the hood remains moderate while the value of the HIC remains less than a predetermined limit value because of the flexible behavior of the SMC.

There follows a description of a method of fabricating the hood 2.

In order to obtain the hood 2, there are provided firstly a metal sheet and secondly an SMC layer, with the operations required for obtaining each of these two components being performed in independent manner. Thus, for example, the sheet is shaped so as to obtain the skin 10, in particular by stamping and/or bending. Separately, the SMC is molded using a mold that makes it possible to obtain the final geometrical configuration for the lining 20.

The skin 10 and the lining 20 as obtained in this way are then assembled together so that the skin covers the lining as shown in FIG. 2, in particular while defining the intermediate empty space V₂. Once they have been assembled together in the proper relative positions, the skin and the lining are secured to each other by the adhesive elements 36 and 37 or by analogous means.

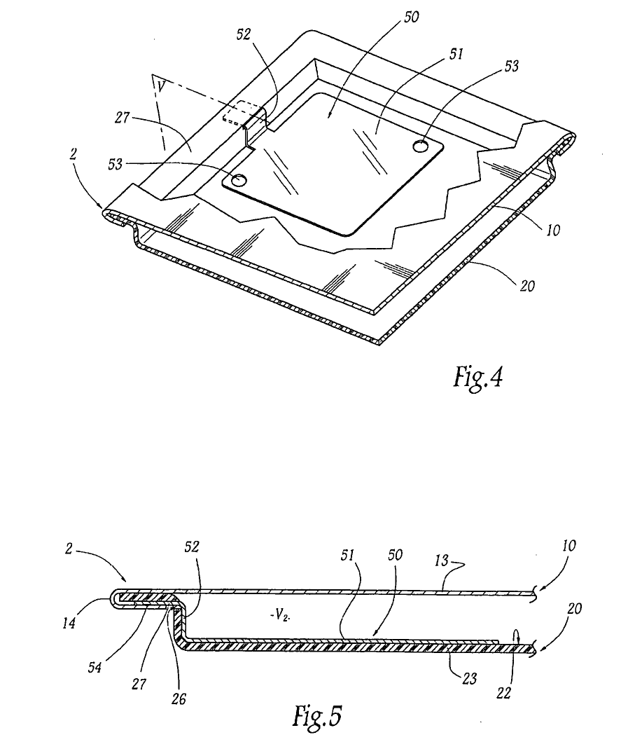

In order to make assembly easier, it is advantageous to make use of a metal baseplate 50 as shown in FIGS. 4 and 5. The baseplate shown is situated in the right rear corner of the hood 2, but in practice a plurality of baseplates are advantageously used, in particular one in each of the two rear corners of the hood.

The baseplate 50 is generally in the form of a plane plate 51 having a bent tab 52 extending from one of its sides and formed integrally with the plate. The baseplate 50 is put into place on the top face 22 of the lining 20 before the lining is assembled to the skin 10: the plate 51 is placed flat on the face 21 while the tab 52 is inserted in a substantially complementary opening 26 formed through the right peripheral edge 27 of the lining. With the baseplate in this position, the plate 51 is secured to the main portion 23 of the lining, e.g. by riveting in zones 53, e.g. via clinch nuts (not shown). Such nuts advantageously enable the baseplate to be caused to carry additional elements of the body of the vehicle 1, e.g. a hinge for opening the hood 2. The skin 10 is then assembled to the lining, with the baseplate 50 then being located inside the volume V₂, as shown in FIG. 5. The tab 52 is then secured to the skin 10, and more precisely to the folded-over right peripheral edge 14 of the skin, by being welded to said edge, as represented by spot weld 54.

The presence of the baseplate(s) 50 thus makes it possible by virtue of the stiffness of the baseplate(s), to prevent the skin 10 and the lining 20 from moving relative to each other so as to enable the hood 2 to be handled for assembly on the body of the motor vehicle 1 being assembled. Subsequently, in particular when the body is dipped in a cataphoresis bath or is subjected to analogous heat treatment, the heat of the treatment causes the adhesive elements 36 and 37 to cross-link, and also the other analogous spots or lines of adhesive, thereby permanently securing the skin and the lining together in their final assembled configuration. It can be understood that the spot weld 54, and also the riveting points 53 need only to present strength that is sufficient to enable the hood 2 to be handled before it is fastened together permanently via the elements 36, 37, and the like.

When, by way of example, the SMC constituting the lining 20 is not conductive or is insufficiently conductive, then using one or more baseplates 50 also serves to enable electricity to be conducted between the skin 10 of the hood 2 and other metal elements of the body of the vehicle 1 when the plate 51 of the baseplate carries those body elements, such as the above-mentioned hinges for opening the hood. The existence of this electrical conductivity enables the hood to be painted with electrostatic paint and/or enables the skin to be used as an anti-inference element. It also makes it possible, without using any other special device, to ensure that the hood 2 is placed at a suitable electrical potential during cataphoresis and/or painting operations.

Various alterations or variants can be made to the hood 2 as described above, and also to its method of fabrication can be envisaged. By way of example:
instead of providing for the adhesive used at the spots 31 and 32 to be cross-linked during cataphoresis of the entire body of the vehicle 1, such cross-linking can be obtained independently of any processing of the remainder of the body, prior to mounting the hood on the remainder of the vehicle; such an operation is to be preferred when the skin is made of a thermoplastic or a composite material;
the intermediate volume V₂ may be filled with a packing material providing that material does not significantly disturb the flexible behavior of the SMC lining 20, and in particular its behavior relative to the metal skin 10; and/or
the operations of painting the hood may be performed prior to mounting the hood on the vehicle, particularly when the hood is assembled to the body after the operations of painting the body.

What is claimed is:

1. A vehicle hood in particular for a motor vehicle, the hood comprising an outer skin and an inner layer of composite material, wherein the layer forms a lining made of SMC and extending essentially at a distance from the skin, and wherein the volume defined between the skin and the lining is left empty.

2. A hood according to claim 1, wherein the skin is made of metal.

3. A hood according to claim 1, wherein the skin is made of thermoplastic or composite material.

4. A hood according to claim 1, wherein, on its face facing away from the skin, the lining presents at least one surface for bearing against a rigid element of the body of the vehicle.

5. A hood according to claim 1, further including at least one rigid baseplate suitable for setting the position of the skin relative to the lining, at least temporarily.

6. A method of fabricating a vehicle hood, in particular for a motor vehicle, in which an outer skin is provided for the hood, wherein during a step that is independent of obtaining the skin, an SMC layer is molded in order to provide an inner lining for the hood, and wherein, after the steps of obtaining the skin and molding the SMC layer, the skin and the lining are permanently connected together so that the skin covers the lining, with the lining extending essentially at a distance from the skin.

7. A method according to claim 6, wherein prior to permanently connecting the skin and the lining together, the skin is secured to the lining by using at least one rigid baseplate that is secured both to the skin and to the lining and that is disposed between the skin and the lining.

8. A method according to claim 7, wherein, with the skin and the baseplate(s) being of a metallic nature, the or each baseplate is secured to the skin by welding or the like, in order to enable electrical conduction between them.

9. A method according to claim 7, wherein in order to connect the skin permanently to the lining when they are secured relative to each other by the baseplate(s), spots or lines of adhesive suitable for being cross-linked are interposed between the skin and the lining, and the adhesive is caused to cross-link preferably while the hood assembled to the remainder of the vehicle is passing through a cataphoresis bath.

10. A method according to claim 7, wherein the or each baseplate is used for carrying mechanical elements associated with the hood, such as a hinge for opening the hood.
